(19) United States
(12) Patent Application Publication
(10) Pub. No.: US 2007/0152658 A1
(43) Pub. Date: Jul. 5, 2007

(54) Magnetically passive position sensor

(76) Inventor: Bernd Pauer, Eppstein (DE)

Correspondence Address: MAYER, BROWN, ROWE & MAW LLP, 71 S. WACKER, CHICAGO, IL, 60606, US

(21) Appl. No.: 10/587,251

(22) PCT Filed: Dec. 22, 2004
(86) PCT No.: PCT/EP04/53661

§ 371 Date: Jul. 26, 2006

(30) Foreign Application Priority Data
Jan. 27, 2004 (DE) 10 2004 004 102.4

(51) Int. Cl. G01B 7/14

(52) U.S. Cl. 324/207.13

(57) ABSTRACT

Disclosed is a passive magnetic position sensor comprising contacting spring elements (5, 6) that can be moved against a resistance device (4) with the aid of a magnet (2) and are provided with two tongues (10,11) by means of which the contacting spring elements (5, 6) face a contact (7). The magnet (2) is able to press both tongues (10, 11) against the contact (7). If one of the tongues (10, 11) is prevented from being contacted as a result of the contact (7) being soiled (12),the other tongue (10, 11) is used for contacting, thus providing the position sensor with high redundancy.

### BACKGROUND OF THE INVENTION

The invention relates to a magnetically passive position sensor with a movable magnet, with a multiplicity of contact spring elements arranged in the range of movement of the magnet, the contact spring elements lying opposite a resistance device and being able to be moved by the magnet against the resistance device, the resistance device having a number of individual electrical contacts, lying opposite the contact spring elements.

Such a position sensor is often used for filling level sensors in fuel tanks of modern motor vehicles and is known for example from DE 196 48 539 A1. The position sensor generates electrical signals in dependence on the position of the magnet. The contact spring elements are formed as a row of resilient tongues electrically connected to one another. One of the tongues in each case lies opposite one of the contacts of the resistance device. If the magnet is moved over the resistance device, the contact spring elements come up against the contacts of the resistance device. A disadvantage of the known position sensor is that soiling of the contacts or of the contact spring elements prevents electrical connection. In this case, the position sensor cannot generate any electrical signals. Therefore, usually a number of contact spring elements, for example three, are moved against three contacts that are adjacent one another. However, here, too, the failure of one of the contact elements leads to falsification of the electrical signals of the position sensor.

The invention is based on the problem of designing a position sensor of the type mentioned at the beginning in such a way that a reduction in the accuracy of the signals in dependence on the position of the magnet as a result of individual dirt particles is largely avoided.

### BRIEF DESCRIPTION OF THE INVENTION

This problem is solved according to the invention by an individual contact of the resistance device being assigned at least two tongues of the contact spring elements.

As a result of this design, if there is a dirt particle sticking to the contact, only the electrical connection of one of the tongues to the contact is prevented. The second tongue can establish the connection with the contact. This contact can therefore generate signals of the position sensor. Consequently, the number of tongues assigned to an individual contact provides redundancy. Therefore, individual dirt particles do not lead to a reduction in the accuracy of the position sensor according to the invention.

The position sensor according to the invention is of a particularly simple structural design if the tongues are each formed as an individual contact spring element.

### BRIEF DESCRIPTION OF THE DRAWINGS

The invention allows numerous embodiments. To illustrate its basic principle further, one of these is described below and is represented in the drawing, in which:

FIG. 1 shows a sectional representation through a position sensor according to the invention,

FIG. 2 shows a sectional representation through the position sensor according to the invention from FIG. 1 along the line II-II.

### DETAILED DESCRIPTION OF THE INVENTION

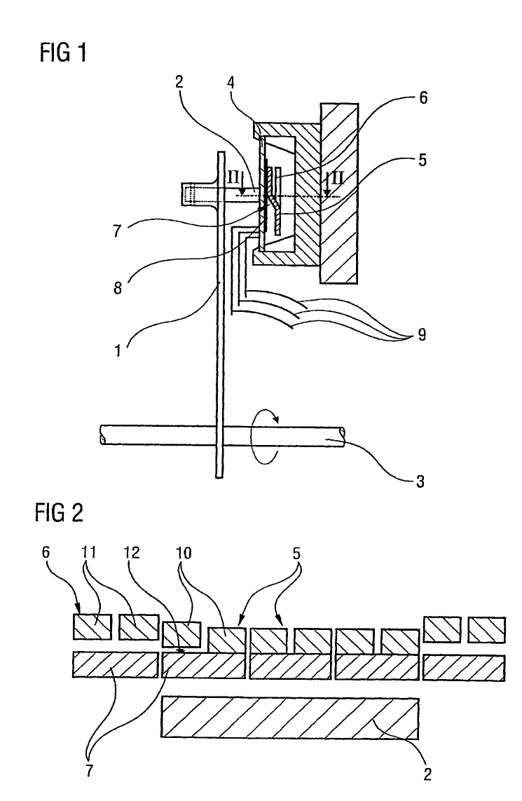

FIG. 1 shows a position sensor with a magnet 2 arranged on a pivoting arm 1. The pivoting arm 1 is fastened on a pivot pin 3. The pivot pin 3 can be connected for example to a float (not represented) of a level sensor of a fuel tank. By means of the pivot pin 3, the magnet 2 is pivoted over a resistance device 4. On the side of the resistance device 4 that is facing away from the magnet 2, magnetic contact spring elements 5, 6 are arranged. The contact spring elements 5, 6 can be attracted by the magnet 2 and pressed against the resistance device 4. The resistance device 4 has a number of contacts 7 lying opposite the contact spring elements 5, 6. The contacts 7 are connected to one another by means of a resistor track 8. As an alternative to this, the contacts could also be arranged on a thick-film network. The resistance device 4 is connected by means of electrical lines 9 to an electronic system (not represented), which senses the position of the magnet 2 by means of the contact spring elements 5, 6 lying against the resistance device 4. This position sensor is described in detail in DE 196 48 539 A1, for which reason reference is expressly made to this document for the disclosure of the structure and function.

FIG. 2 shows a sectional representation through the position sensor from FIG. 1, the contact spring elements each having two tongues 10, 11 lying opposite an individual contact. The magnet 2 contacts altogether three contacts 7 with the contact spring elements 5. Soiling 12, which prevents contacting with one of the tongues 10 of the contact spring element 5, is represented on one of the contacts 7 by way of example. The contact 7 is contacted by the second tongue 10 of the contact spring element 5 lying opposite this contact 7.

1. A magnetically passive position sensor with a movable magnet, with a multiplicity of contact spring elements arranged in the range of movement of the magnet, the contact spring elements lying opposite a resistance device and being able to be moved by the magnet against the resistance device, the resistance device having a number of individual electrical contacts, lying opposite the contact spring elements, characterized in that an individual contact (7) of the resistance device (4) is assigned at least two tongues (10, 11) of the contact spring elements (5, 6).

2. The magnetically passive position sensor as claimed in claim 1, characterized in that the tongues (10, 11) are each formed as an individual contact spring element (5, 6).
